(19) United States
(12) Patent Application Publication
(10) Pub. No.: US 2021/0330112 A1
(43) Pub. Date: Oct. 28, 2021

(54) Fast Fit Mini Blind Bracket

(71) Applicant: Kenney Manufacturing Company, Warwick, RI (US)

(72) Inventor: Michael P. Hanley, Smithfield, RI (US)

(21) Appl. No.: 17/230,619

(22) Filed: Apr. 14, 2021

Related U.S. Application Data
(60) Provisional application No. 63/015,201, filed on Apr. 24, 2020.

(51) Int. Cl. A47H 1/14

(52) U.S. Cl. CPC A47H 1/14; E06B 9/24

(57) ABSTRACT

A fast fit mini blind bracket includes a bracket, the bracket including a first region and a second region oriented perpendicular to each other, the first region and the second region including at least one centrally located aperture, a fastener end, and a fastener, the fastener configured to secure the bracket to a surface.

### CROSS REFERENCE TO RELATED APPLICATIONS

This application claims benefit from U.S. Provisional Patent Application Ser. No. 63/015,201, filed Apr. 24, 2020, which is incorporated by reference in its entirety.

### BACKGROUND OF THE INVENTION

The present invention generally relates to curtain rod brackets, and more specifically to a fast fit mini blind bracket.

In general, prior bracket designs require that brackets are screwed into the window casing. This can often be cumbersome due to tight working space within a window casing. And if pilot holes must be drilled, a hand drill used to drill the pilot holes is often difficult to maneuver within the window casing. With existing bracket designs, an installer must handle the bracket, screw and drill simultaneously within a tight space. At best, this makes installation difficult.

### BRIEF SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a fast fit mini blind bracket including a bracket, the bracket including a first region and a second region oriented perpendicular to each other, the first region and the second region including at least one centrally located aperture, a fastener end, and a fastener, the fastener configured to secure the bracket to a surface.

In another aspect, the invention features a fast fit mini blind bracket including a bracket, the bracket including a first region and a second region oriented perpendicular to each other and including an inner portion that is seated within an outer portion, the first region and the second region including at least one centrally located aperture, a fastener end, and a fastener, the fastener configured to secure the bracket to a surface.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE SEVERAL VIEWS OF THE DRAWING

These and other features, aspects, and advantages of the present invention will become better understood with reference to the following description, appended claims, and accompanying drawings where:

FIG. 1 is an exemplary fast fit mini blind bracket.

FIG. 2 is an exemplary fast fit mini blind bracket.

FIG. 3 is an exploded view of an exemplary fast fit mini blind bracket.

FIG. 4 is a side view of a top mount of an exemplary fast fit mini blind bracket.

FIG. 5 is a front view of a top mount of an exemplary fast fit mini blind bracket.

FIG. 6 is a prospective view of a side mount of an exemplary fast fit mini blind bracket.

FIG. 7 is a front view of a side mount of an exemplary fast fit mini blind bracket.

FIG. 8 is a side view of a side mount of an exemplary fast fit mini blind bracket.

### DETAILED DESCRIPTION OF THE INVENTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

This present invention provides a fast fit mini blind bracket designed to be advantageous when working within a window casing with limited room.

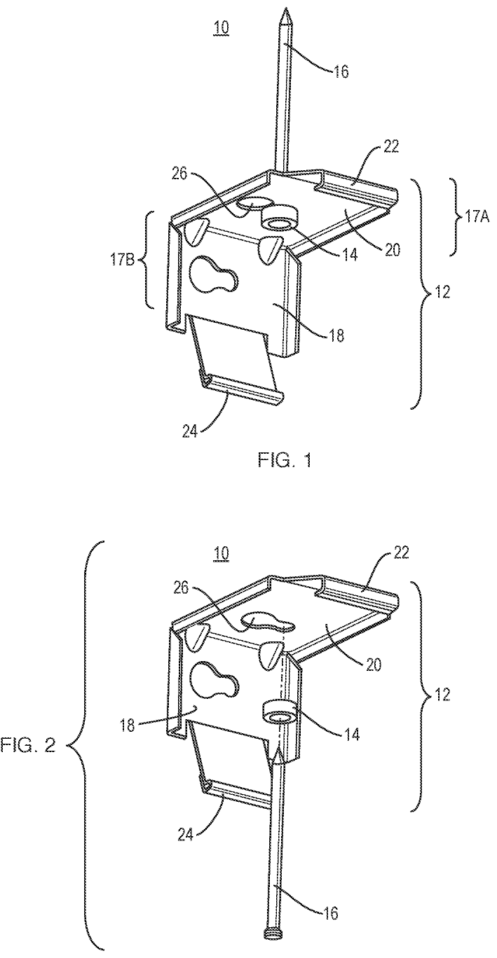

In FIG. 1 and FIG. 2, an exemplary fast fit mini blind bracket 10 includes a bracket 12, a fastener end 14 and a fastener 16. In this instance, the fastener 16 is a nail. In other implementations, other suitable fasteners 10 may be employed, such as a screw.

The bracket 12 includes two regions 17A, 17B oriented perpendicular to each other. The regions 17A, 17B enable the fast fit mini blind bracket 10 to be secured to any surface, such as, for example, a wall, a window trim, a ceiling, and so forth.

The bracket 12 includes an inner portion 18 that is seated within an outer portion 20. Opposite ends 22, 24 are configured in a geometric shape to receive a mini blind head rail (not shown) once the bracket 12 is affixed to a surface, such as a window casing, wall or ceiling.

Both the inner portion 18 and outer portion 20 include at least one aperture 26 to receive the fastener 16.

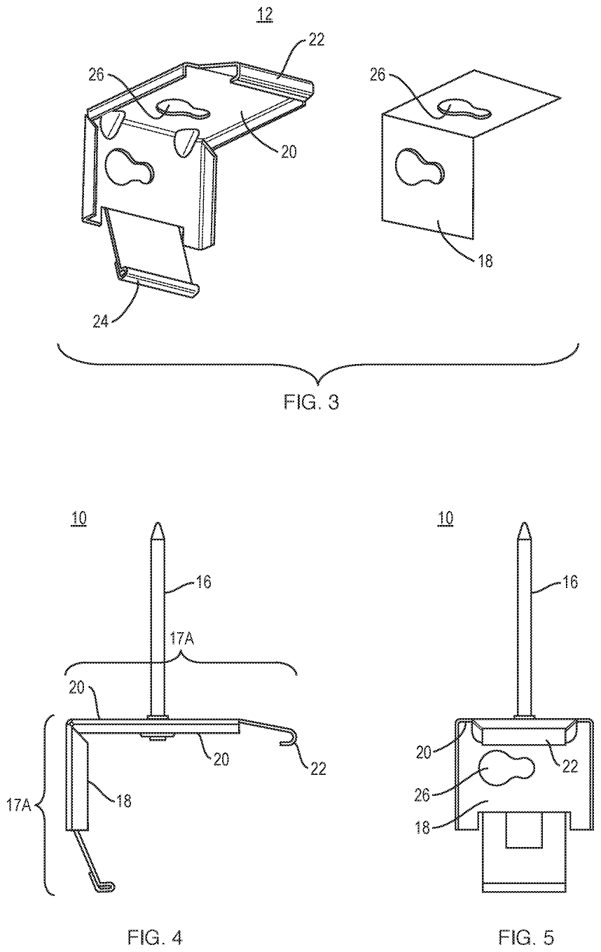

In FIG. 3, the inner portion 18 and the outer portion 20 of the bracket 12 are illustrated. As described above, the inner portion 18 is configured to be seated and mate with/within the outer portion 20.

In FIG. 4, a side view of the exemplary fast fit mini blind bracket 10 is illustrated. Here, the geometric shape of the opposite ends 22, 24 are more clearly shown. This geometric design facilitates receipt of a mini blind head rail. In addition, the regions 17A, 17B are more clear seen as oriented perpendicular to each other.

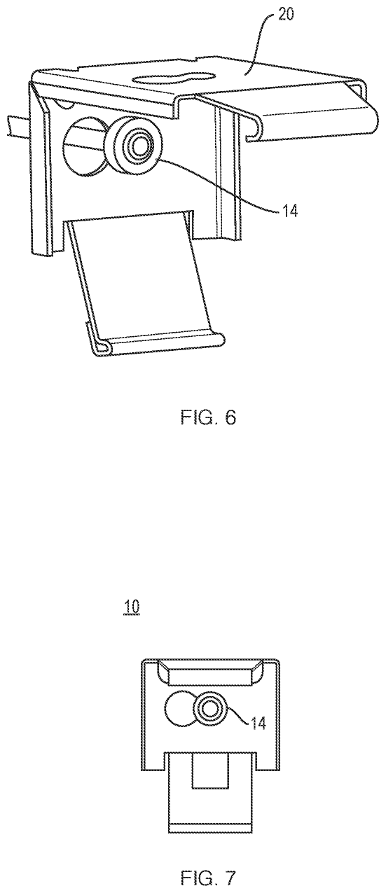

In FIG. 5, a front view of the exemplary fast fit mini blind bracket 10 is illustrated.

FIG. 6 is a prospective view of a side mount of an exemplary fast fit mini blind bracket.

FIG. 7 is a front view of a side mount of an exemplary fast fit mini blind bracket.

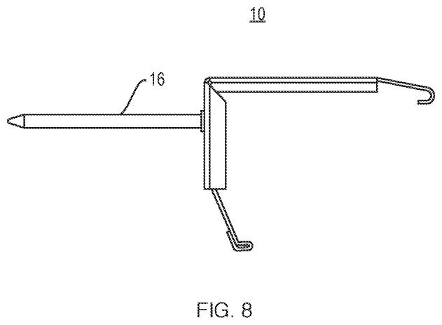

FIG. 8 is a side view of a side mount of an exemplary fast fit mini blind bracket.

To install the fast fit mini blind bracket 10, the inner and outer portions 18, 20 are joined together, a fastener 16 is placed within the aperture 26 and driven into a surface, and a mini blind head rail is snapped into the opposite ends 22, 24. The fast fit mini blind bracket 10 may be mounted, for example, within a window casing or on a front of a window casing.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A fast fit mini blind bracket comprising:
a bracket, the bracket including a first region and a second region oriented perpendicular to each other, the first region and the second region including at least one centrally located aperture;
a fastener end; and
a fastener, the fastener configured to secure the bracket to a surface.

2. The fast fit mini blind bracket of claim 1 wherein the bracket further comprises an inner portion that is seated within an outer portion.

3. The fast fit mini blind bracket of claim 1 wherein the bracket further comprises:
a geometrically shaped end piece on the first region; and
a geometrically shaped end piece on the second region, the geometrically shaped end piece on the first region and the geometrically shaped end piece on the second region configured to receive a mini blind head rail.

4. The fast fit mini blind bracket of claim 3 wherein the inner portion and the outer portion include the at least one aperture to receive the fastener.

5. The fast fit mini blind bracket of claim 1 wherein the fastener is a nail.

6. The fast fit mini blind bracket of claim 1 wherein the fastener is a screw.

7. The fast fit mini blind bracket of claim 1 wherein the surface is a wall.

8. The fast fit mini blind bracket of claim 1 wherein the surface is a ceiling.

9. The fast fit mini blind bracket of claim 1 wherein the surface is a window molding.

10. A fast fit mini blind bracket comprising:
a bracket, the bracket including a first region and a second region oriented perpendicular to each other and comprising an inner portion that is seated within an outer portion, the first region and the second region including at least one centrally located aperture;
a fastener end; and
a fastener, the fastener configured to secure the bracket to a surface.

11. The fast fit mini blind bracket of claim 10 wherein the bracket further comprises:
a geometrically shaped end piece on the first region; and
a geometrically shaped end piece on the second region, the geometrically shaped end piece on the first region and the geometrically shaped end piece on the second region configured to receive a mini blind head rail.

12. The fast fit mini blind bracket of claim 11 wherein the inner portion and the outer portion include the at least one aperture to receive the fastener.

13. The fast fit mini blind bracket of claim 10 wherein the fastener is a nail.

14. The fast fit mini blind bracket of claim 10 wherein the fastener is a screw.

15. The fast fit mini blind bracket of claim 10 wherein the surface is a wall.

16. The fast fit mini blind bracket of claim 10 wherein the surface is a ceiling.

17. The fast fit mini blind bracket of claim 10 wherein the surface is a window molding.
